(19) United States
(12) Patent Application Publication
(10) Pub. No.: US 2015/0003770 A1
(43) Pub. Date: Jan. 1, 2015

(54) ROLLING BEARING, IN PARTICULAR FOR A STEERING COLUMN, AND ASSOCIATED PRODUCTION METHOD

(71) Applicant: Aktiebolaget SKF, Goteborg (SE)

(72) Inventors: Sylvain Bussit, Monnaie (FR); Yichun Feng, Shangai (CN); Wilfried Hermle, Irndorf (DE); Daniel Jansen, Tours (DE); Tommy Jullien, Tours (FR); Thomas Lepine, Villandry (FR); Bruno Montboeuf, CERELLES (FR); Lucia Pintz, Buchheim (DE); Heiko Waeschle, Messstetten (DE)

(21) Appl. No.: 14/319,766

(22) Filed: Jun. 30, 2014

(30) Foreign Application Priority Data
Jun. 28, 2013 (FR) 1356258

(51) Int. Cl. F16C 33/58; B23P 15/00

(52) U.S. Cl. CPC F16C 33/585; B23P 15/003
USPC 384/569; 29/898.066

(57) ABSTRACT

A rolling bearing for a steering column having an inner ring, an outer ring and at least one row of rolling elements disposed between the rings is provided. The bearing includes a housing and at least one wire disposed in the housing to form a rolling raceway of the ring, the wire being wound about a circumferential winding axis and having a radial gap. The rolling raceway of the wire includes a circular main track and at least one end track which extends the main track in the circumferential direction and which is adjacent to the gap. The end track is offset radially towards the winding axis of the wire in relation to the main track.

### CROSS-REFERENCE TO RELATED APPLICATIONS

This application claims priority to French Patent Application No. FR1356258 filed on Jun. 28, 2013, the contents of which are hereby fully incorporated by reference.

### FIELD OF THE INVENTION

The present invention relates to the field of rolling bearings, and in particular those used in steering columns of motor vehicles.

### BACKGROUND OF THE INVENTION

Steering columns generally comprise a shaft, one end of which is fixedly joined to a steering wheel which is operated by the driver of the vehicle and the other end of which is fixedly joined to mechanical members which are intended to ensure the angular positioning of the wheels of the vehicle. The shaft of the steering column is mounted for rotation in a tubular casing by means of two rolling bearings. One type of rolling bearing for a steering column comprises an inner ring, an outer ring and a row of balls which are arranged between rolling raceways of the rings, at least one of the rings comprising a housing and two strips or wires which are arranged in the housing in order to form rolling raceways of the ring. A rolling bearing which has three or four contact locations and which is capable of operating under axial and/or radial loads is thereby produced. Generally, such a bearing also comprises a resilient biasing element which is mounted inside the housing and which moves into axial abutment with one of the wires so as to bring about operation without play. For further details concerning such a type of rolling bearing, reference may be made, for example, to the patent application EP-A1-1956254.

Each wire of such a bearing forming a rolling raceway is generally constructed from a steel wire which is wound in the form of a torus and the end faces of which move opposite each other in the circumferential direction during positioning in the associated housing. After mounting, a radial gap remains between the end faces of each wire.

During operation, noises are produced during the rolling of the balls on the rolling raceways of the ring, which raceways are formed by the wound wires. This is because, at the inlet of the radial gap of each of those wires, each ball has the tendency to become introduced inside this gap and to move into abutment against one of the end faces of the wire, in particular under the effect of the axial biasing load applied by the resilient element. Subsequently, at the outlet from the gap, the ball moves radially in the direction of the other ring and moves into abutment against the rolling raceway(s) of the ring. During the rolling of the balls along the wires, there is thereby produced a succession of impacts when the balls reach the radial gaps, which causes noise.

Therefore, an object of the present invention is to overcome this disadvantage.

### SUMMARY OF THE INVENTION

More specifically, an object of the present invention is to provide a rolling bearing, in particular for a steering column of a motor vehicle, which is easy to produce, to mount and which allows operation with limited noise production.

In an embodiment, the rolling bearing, in particular for a steering column, comprises an inner ring, an outer ring and at least one row of rolling elements which are arranged between the rings, at least one of the rings comprising a housing and at least one wire which is arranged in the housing in order to form a rolling raceway of the ring. The wire is wound about a circumferential winding axis and has a radial gap. The rolling raceway of the wire comprises a circular main track and at least one end track which extends the main track in the circumferential direction and which is adjacent to the gap. The end track is offset radially towards the winding axis of the wire in relation to the main track.

The end track of the rolling raceway of the wire preferably has at least one portion inclined in the direction of the winding axis and the radial gap. The connection angle between the end track and the main track of the winding raceway of the wire may advantageously be less than or equal to 45 degrees.

The wire may comprise end faces which delimit the radial gap, the end track of the rolling raceway of the wire being connected to one of the end faces.

In an embodiment, the rolling raceway of the wire comprises two end tracks which each extend an end of the main track and which are symmetrical to each other in relation to a radial centre plane of the wire.

The bearing may comprise two identical wires which are arranged in the housing. The radial gap of a wire is preferably offset in the circumferential direction relative to the radial gap of the other wire.

In an embodiment, the end track of the rolling raceway of the wire comprises at least one frustoconical portion which is inclined in the direction of the winding axis of the wire and the radial gap. Alternatively, the end track of the rolling raceway of the wire may comprise at least one concave portion or convex portion.

In an embodiment, the ring comprises at least one biasing element which is mounted in the housing and which applies an axial load to the wire.

The invention also relates to a steering column which comprises a casing, a shaft which is coaxial relative to the casing and at least one rolling bearing which is described above and which is mounted radially between the casing and the shaft.

The invention further relates to a production method for a rolling bearing described above, comprising a step of producing the wire in which at least one notch is formed in a metal wire, the metal wire is cut substantially at the centre of the notch so as to form the end track of the wire, and the wire is wound in the form of an open strip, and a step of mounting the wire produced, in which the wound wire is introduced inside the associated housing.

### BRIEF DESCRIPTION OF THE DRAWINGS

The present invention will be better understood from a reading of the detailed description of embodiments taken by way of non-limiting examples which are illustrated by the appended drawings, in which:

FIG. 1 is an axial cross section of a rolling bearing according to a first embodiment of the invention,

FIG. 2 is a cross section along the axis II-II of FIG. 1,

FIG. 3 is a side view of a wire of the rolling bearing of FIGS. 1 and 2,

FIG. 4 is an axially sectioned half-view of a rolling bearing according to a second embodiment of the invention,

FIG. 5 is a cross section along the axis V-V of FIG. 4,

FIG. 6 is a partial cross section in accordance with axis VI-VI of FIG. 4 of a wire of the rolling bearing,

FIG. 7 is an axially sectioned half-view of a rolling bearing according to a third embodiment of the invention,

FIG. 8 is an axially sectioned half-view of a rolling bearing according to a fourth embodiment of the invention,

FIG. 9 is a cross section in accordance with axis IX-IX of FIG. 8 and

FIG. 10 is a partial cross section in accordance with axis X-X of FIG. 8 of a wire of the rolling bearing.

### DETAILED DESCRIPTION OF THE INVENTION

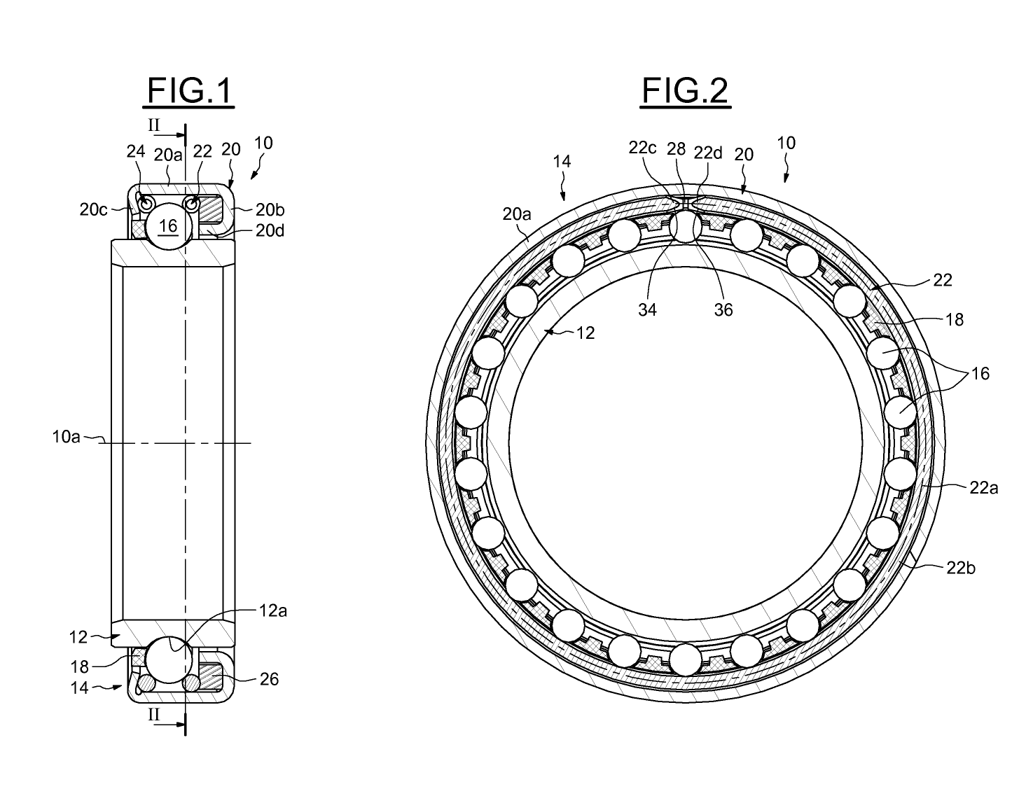

In FIGS. 1 and 2, the rolling bearing which is generally designated 10 and which has an axis 10a comprises an inner ring 12, an outer ring 14, a row of rolling elements 16 which are arranged between rolling raceways of the rings and which are produced in this instance in the form of balls, and a cage 18 which is arranged radially between the rings in order to maintain a regular circumferential spacing between the rolling elements.

The inner ring 12 comprises a cylindrical hole which is axially delimited by opposing radial front surfaces and an axial outer cylindrical surface, from which there is formed a toroidal circular groove 12a which has in cross section a concave internal profile which is capable of forming a rolling raceway for the rolling elements 16, the groove being orientated radially outwards. The inner ring 12 is solid. The term “solid ring” is intended to be understood to be a ring whose form is obtained by machining with removal of swarf (turning, grinding) from tubes, bars, forged and/or rolled blanks.

The outer ring 14 comprises an outer housing 20 and two separate strips or wires 22, 24 which form rolling paths or raceways of the ring for the rolling elements 16. The outer ring 14 also comprises a biasing element 26 so as to obtain operation without play. The wires 22, 24 and the biasing element 26 are mounted inside the housing 20.

The housing 20 may advantageously be produced by cutting and swaging a sheet metal plate. The annular housing 20 comprises an axial outer portion 20a which is extended, at each end, radially inwards by a radial portion 20b, 20c. The wires 22, 24 are arranged in radial contact with the hole of the axial portion 20a and are symmetrical relative to a radial plane which extends through the centre of the rolling elements 16. The radial portion 20c has a radial dimension which is less than that of the radial portion 20b and also has a smaller thickness in order to be slightly curved inwards in the direction of the rolling elements 16 so as to move into abutment against the wire 24 and to axially bias the bearing. The cage 18 is arranged radially between the free edge of the radial portion 20c of the housing and the outer surface of the inner ring 12.

The housing 20 also comprises an axial inner portion 20d which axially extends inwards an edge of the radial portion 20b, which edge has a small diameter. The axial portion 20d is provided for centring the biasing element 26 inside the housing 20.

The biasing element 26 which is annular is mounted axially in contact against the radial portion 20b of the housing and the wire 22 and radially between the axial outer portion 20a and axial inner portion 20d, while remaining spaced apart therefrom. A radial surface of the biasing element 26 is in axial contact with the inner face of the radial portion 20b and an opposing radial surface is in axial contact with the wire 22. The biasing element 26 remains spaced apart from the rolling elements 16. The biasing element 26 applies a permanent axial load to the wire 22 which tends to bias the rolling elements 16 on the other wire 24 and on the groove 12a of the inner ring. The biasing element 26 is advantageously formed from a resilient material, for example, an elastomer material such as nitrile rubber or polyurethane. In the embodiment illustrated, the resilient ring 16 is in the form of a torus having a square cross section. In a variant, it could be possible to provide a resilient ring having a different profile in cross section, for example, circular.

The wires 22, 24 are two separate and identical components so as to reduce the production cost. The wires 22, 24 are in the form of open tori and are mounted inside the housing 20 in direct contact therewith. The rolling elements 16 are arranged between the wires 22, 24 of the outer ring 14 and the groove 12a of the inner ring 12 which form rolling raceways. A rolling bearing 10 having three contact locations is thereby produced.

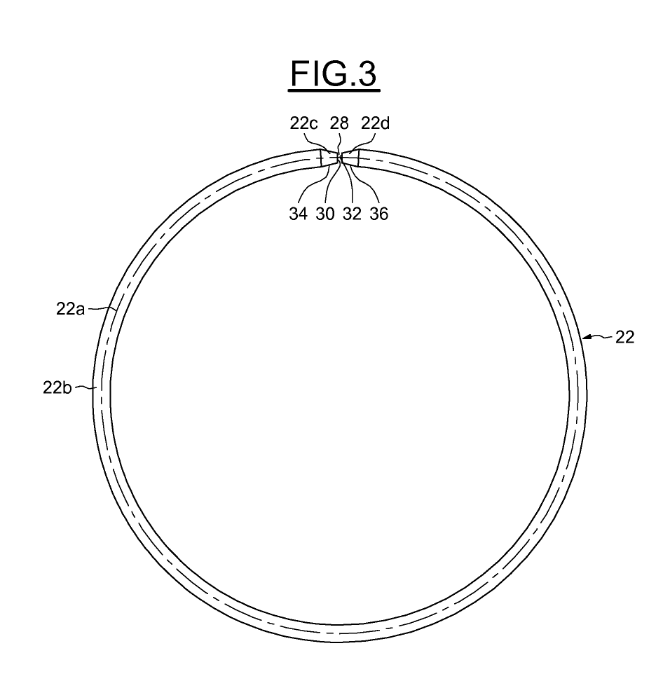

Since the wires 22, 24 are identical in this embodiment, only the wire 22 will be described here. The wire 22 is wound about itself along a circumferential winding axis 22a and comprises a cylindrical member 22b and first and second end or terminal portions 22c, 22d which each extend the member at one end in the circumferential direction. The member 22b and the end portions 22c, 22d of the wire each have in cross section a circular profile. The end portions 22c, 22d are opposite and spaced from each other in the circumferential direction. The wire 22 comprises a radial gap 28 which is delimited in the circumferential direction by end faces 30, 32 (FIG. 3) of the end portions. The end portions 22c, 22d are adjacent to the gap 28 and symmetrical to each other in relation to a radial plane of the wire 22 which extends through the centre of the gap. The end faces 30, 32 are opposite each other and delimit the wire 22 in the circumferential direction. The wire 22 is open at a location of its circumference, that is to say, it is discontinuous in the circumferential direction.

Each end portion 22c, 22d of the wire comprises an annular frustoconical surface 34, 36 which extends in the direction of the winding axis 22a and the gap 28. The frustoconical surface 34, 36 is connected, on the one hand, to the cylindrical outer surface of the member 22b and, on the other hand, to the associated end face 30, 32. The frustoconical surfaces 34, 36 are adjacent to the gap 28 and symmetrical to each other in relation to the radial plane of the wire 22 which extends through the centre of the gap. In the embodiment illustrated, the connection angle between the outer surface of the member 22b and the frustoconical surface 34, 36 is in the order of 30 degrees. That angle is preferably less than or equal to 45 degrees. The diameter of the frustoconical surface 34, 36 is strictly less than that of the outer surface of the member 22b of the wire.

Each frustoconical surface 34, 36 of the wire forms a frustoconical end track for the rolling elements 16 which is inclined towards the winding axis 22a of the wire and which is offset radially towards the axis relative to a main circular track which is formed by the outer surface of the member 22b. The rolling raceway of the wire 22 is thereby formed by the circular main track and the two frustoconical end tracks, each end track extending an end of the main track in the circumferential direction.

During a rotation of the rolling elements 16 in the clockwise direction and during the movement into the region of the gap 28 of the wire 22, each rolling element 16 moves from the circular main track of the member 22b of the wire to the frustoconical end track 34 of the first end portion 22c. This brings about a slight radial displacement of the rolling element 16 outwards. Subsequently, the rolling element 16 rolls along the frustoconical end track 36 of the second end portion 22d of the wire, and is thereby brought radially inwards until it again reaches the circular main track of the member 22b of the wire.

The provision of the frustoconical surfaces 34, 36 at the end portions 22c, 22d of the wire forming end ramps which are inclined towards the gap 28 allows the impacts to be limited between the rolling elements 16 and the end faces 30, 32 of the wire during the rotation of the rolling elements in the clockwise direction and counter-clockwise direction. As a result of those end tracks offset towards the winding axis 22a of the wire relative to the circular main track, the axial biasing load applied to the rolling elements 16 is reduced in the region of the gap 28 of the wire. The movement of the rolling elements 16 along the gap 28 is carried out without impacts between the tracks of the inner ring 12 and outer ring 14. This allows a great reduction in the production of noise during operation.

In order to produce the rolling bearing 10, it is advantageous to provide for a step of producing the wires 22, 24. Each wire may be produced from a steel wire in which there are formed, for example, by punching, two annular notches of biconical and identical form. The metal wire is subsequently cut substantially at the centre of each notch in order to obtain the wire 22, 24 provided with the end portions. The wire is subsequently wound in the form of an open strip so as to bring the end faces opposite each other. After this production step, the wire is introduced inside the housing 20.

In the embodiment illustrated, the end portions of each wire 22, 24 are each provided with an annular frustoconical surface which forms an end track which is offset towards the winding axis 22a relative to the circular main track. In a variant, it could be possible to provide only, for each of those end portions, a countersinking of frustoconical form in the region provided for the rolling of the rolling elements 16 which is limited in the circumferential direction, that is to say, non-annular.

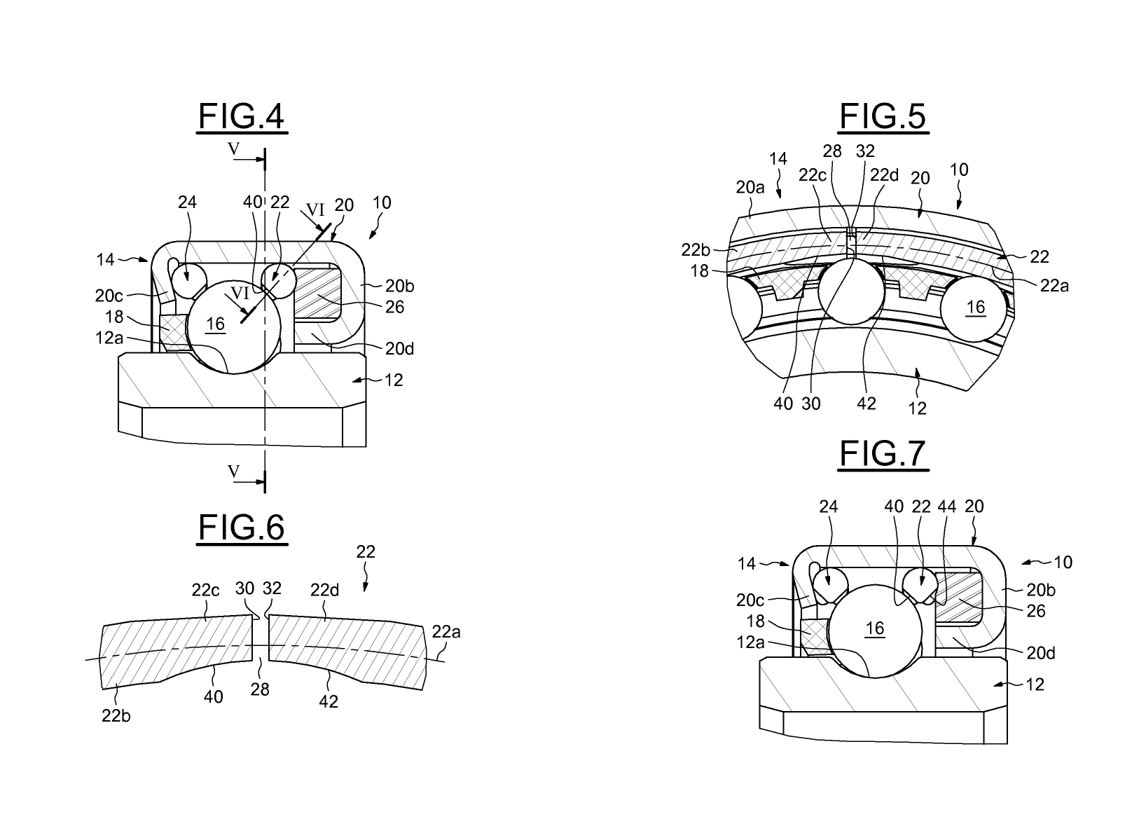

The embodiment illustrated in FIGS. 4 to 6, in which elements which are identical have the same reference numerals, differs in that each end portion 22c, 22d of the wire 22 locally comprises a circular groove 40, 42 which has in cross section a concave internal profile and which forms an end track for the rolling elements 16, the groove being orientated radially inwards in the direction of the rolling elements. The groove 40, 42 is connected, on the one hand, to the outer surface of the member 22b and, on the other hand, to the associated end face 30, 32. The connection portion of the groove 40, 42 at the outer surface of the member 22b is inclined in the direction of the winding axis 22a and the gap 28. The connection angle between the outer surface of the member 22b and the connection portion is in the order of 30 degrees. The grooves 40, 42 are symmetrical to each other in relation to the radial plane of the wire 22 which extends through the centre of the gap 28.

Each groove 40, 42 of the wire forms a concave portion which delimits an end track for the rolling elements 16 which is offset radially towards the winding axis 22a relative to the circular main track formed by the outer surface of the member 22b. In this embodiment, the wire 24 is also identical to the wire 22.

The embodiment illustrated in FIG. 7 in which identical elements have the same reference numerals differs from the embodiment previously described only in that each end portion 22c, 22d of the wire 22 comprises two grooves 40, 44 which are symmetrical to each other in relation to a radial centre plane which extends through the centre of the wire. The groove 44 is orientated in the direction of the biasing element 26. In this embodiment, the wire 24 is also identical to the wire 22. In relation to the embodiment previously described, this configuration allows the introduction of the wires 22, 24 inside the housing 20 associated with a predetermined assembly direction to be avoided. In another variant, it could further be possible to provide for each end portion of the wire 22, 24 an annular groove which forms an end track for the rolling elements 16.

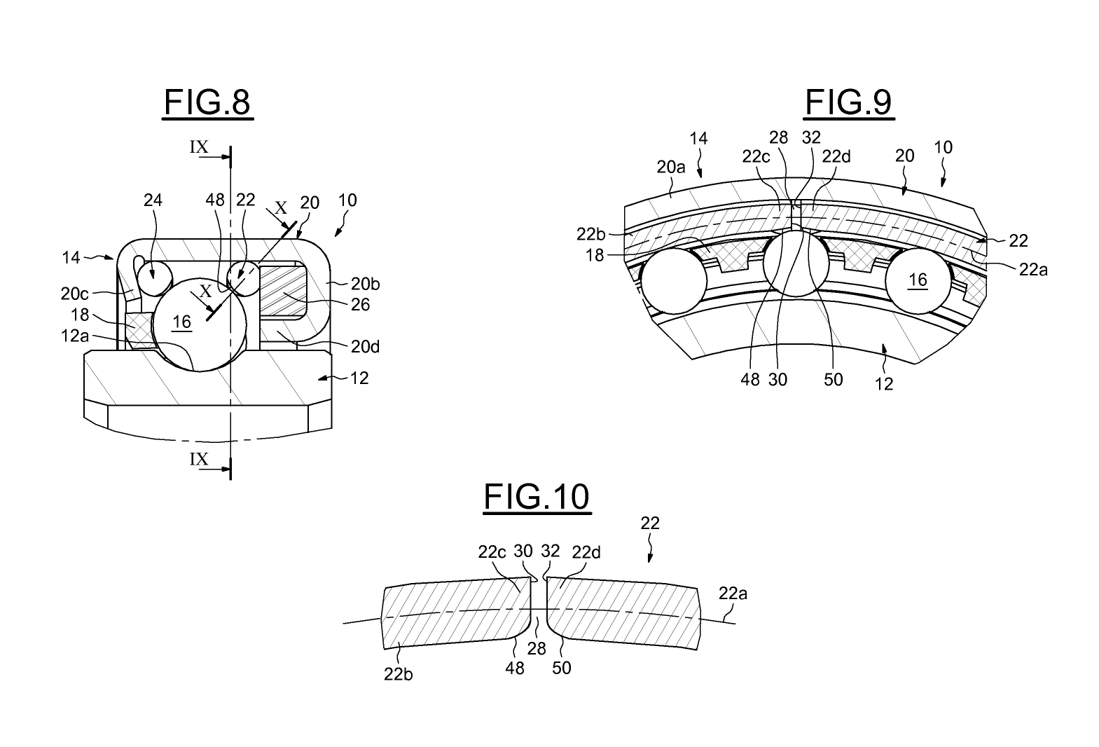

The embodiment illustrated in FIGS. 8 to 10, in which identical elements have the same reference numerals, differs in that each end portion 22c, 22d of the wire 22 locally comprises a convex portion 48, 50 which forms an end track for the rolling elements 16, the convex portion being orientated radially inwards in the direction of the rolling elements. The convex portion 48, 50 is tangentially connected, on the one hand, to the outer surface of the member 22b and, on the other hand, to the associated end face 30, 32. The convex portion 48, 50 is inclined in the direction of the winding axis 22a and the gap 28. The convex portions 48, 50 are symmetrical to each other in relation to the radial plane of the wire 22 which extends through the centre of the gap 28.

Each convex portion 48, 50 of the wire forms an end track for the rolling elements 16 which is offset radially towards the winding axis 22a of the wire relative to the circular main track which is formed by the outer surface of the member 22. The wire 24 is identical to the wire 22.

In this embodiment, each end portion 22c, 22d of the wire 22 comprises a single convex portion 48, 50. In a variant, it could be possible to provide, for each end portion of each of the wires, two convex portions which are symmetrical to each other in relation to a radial centre plane which extends through the centre of the wire. In another variant, it could further be possible to provide for each end portion of each of the wires an annular convex portion.

In the embodiments illustrated, the gaps of the wires 22, 24 are located in the same radial plane of the bearing. However, it may be advantageous to offset the gaps relative to each other in the circumferential direction so as to further reduce the noise generated during operation.

In the embodiments illustrated, the rolling bearing comprises a solid inner ring and an outer ring which is provided with an outer housing and two separate wires which form rolling raceways which are mounted in the housing. In a variant, it could be possible to provide for an inverted arrangement for the inner and outer rings, that is to say, a solid outer ring and an inner ring which comprises two wires which form rolling raceways and an inner housing inside which the wires are mounted. In another variant, the inner and outer rings could each comprise a housing and two associated wires.

As a result of the invention, there is provided a rolling bearing which is provided with at least one ring which comprises a housing and at least one wound wire which is arranged in the housing in order to form a rolling raceway of the ring. The rolling raceway of the wire comprises a circular main rolling track and at least one end rolling track which extends the main track in the circumferential direction and which is arranged in an end portion of the wire adjacent to the gap. The distance between the end track and the winding axis of the wire is less than the distance between the main track and the axis. The end track is further preferably inclined in the direction of the rolling axis.

1. A rolling bearing for a steering column, comprising:
an inner ring,
an outer ring, and
at least one row of rolling elements disposed between the rings, wherein
at least one of the rings provides a housing and at least one wire disposed in the housing to form a rolling raceway of the ring, the wire being wound about a circumferential winding axis and having a radial gap, and wherein
the rolling raceway of the wire having a circular main track and at least one end track that extends the main track in the circumferential direction and is adjacent to the gap, the end track being offset radially towards the winding axis of the wire in relation to the main track.

2. The bearing according to claim 1, wherein the end track of the rolling raceway of the wire has at least one portion inclined in the direction of the winding axis and the radial gap.

3. The bearing according to claim 1, wherein the connection angle between the end track and the main track of the winding raceway of the wire is less than or equal to 45 degrees.

4. The bearing according to claim 1, wherein the wire comprises end faces that delimit the radial gap, the end track of the rolling raceway of the wire being connected to one of the end faces.

5. The bearing according to claim 1, wherein the rolling raceway of the wire comprises two end tracks that extend an end of the main track and are symmetrical to each other in relation to a radial centre plane of the wire.

6. The bearing according to claim 1, further comprising two identical wires disposed in the housing.

7. The bearing according to claim 6, wherein the radial gap of a wire is offset in the circumferential direction relative to the radial gap of the other wire.

8. The bearing according to claim 1, wherein the end track of the rolling raceway of the wire further comprises at least one frustoconical portion inclined in the direction of the winding axis of the wire and the radial gap.

9. The bearing according to claim 1, wherein the end track of the rolling raceway of the wire further comprises at least one concave portion.

10. The bearing according to claim 1, wherein the end track of the rolling raceway of the wire further comprises at least one convex portion.

11. The bearing according to claim 1, wherein the ring further comprises at least one biasing element mounted in the housing and applies an axial load to the wire.

12. A steering column comprising:
a casing,
a shaft coaxially relative to the casing, and
at least one rolling bearing mounted radially between the casing and the shaft, the rolling bearing having;
an inner ring,
an outer ring, and
at least one row of rolling elements disposed between the rings, wherein
at least one of the rings provides a housing and at least one wire disposed in the housing to form a rolling raceway of the ring, the wire being wound about a circumferential winding axis and having a radial gap, and wherein
the rolling raceway of the wire having a circular main track and at least one end track that extends the main track in the circumferential direction and is adjacent to the gap, the end track being offset radially towards the winding axis of the wire in relation to the main track.

13. A method of producing a rolling bearing, comprising the steps of:
providing an inner ring, an outer ring, and at least one row of rolling elements disposed between the rings, wherein at least one of the rings provides a housing and at least one wire disposed in the housing to form a rolling raceway of the ring, the wire being wound about a circumferential winding axis and having a radial gap, and wherein the rolling raceway of the wire having a circular main track and at least one end track that extends the main track in the circumferential direction and is adjacent to the gap, the end track being offset radially towards the winding axis of the wire in relation to the main track, producing a metal wire by
forming at least one notch in a metal wire,
cutting the metal wire at the center of the notch to form the end track of the wire,
winding the wire in the form of an open strip,
mounting the produced wound wire inside the housing.
